(19) United States
(12) Patent Application Publication
(10) Pub. No.: US 2022/0227039 A1
(43) Pub. Date: Jul. 21, 2022

(54) APPARATUS AND PROCESS FOR FORMING A MEMENTO FROM CREMATION REMAINS

(71) Applicants: Jane Elizabeth Hudspeth, Andalusia, AL (US); John Edward Ryznic, Fellsmere, FL (US)

(72) Inventors: Jane Elizabeth Hudspeth, Andalusia, AL (US); John Edward Ryznic, Fellsmere, FL (US)

(21) Appl. No.: 17/657,848

(22) Filed: Apr. 4, 2022

Related U.S. Application Data
(63) Continuation of application No. 17/316,839, filed on May 11, 2021, now abandoned.
(60) Provisional application No. 63/024,135, filed on May 13, 2020.

(51) Int. Cl. B29C 64/106; B33Y 80/00; B33Y 10/00

(52) U.S. Cl. CPC B29C 64/106; B33Y 10/00; B33Y 80/00

(57) ABSTRACT

An apparatus and a process for forming a 3D object from the remains of a cremated deceased person or a pet. One method is to mix the cremated remains with a bonding agent such as a resin into a mold having the shape of the desired 3D image. Another method is to use a 3D printing process to print the 3D object using the cremated remains as the powder in the printing process. Once the 3D object is formed, it can be painted to resemble the person or pet in which the cremated remains is used to form the object.

### CROSS REFERENCE TO RELATED APPLICATIONS

This application claims the benefit to U.S. application Ser. No. 17/316,839 filed on May 11, 2021 and entitled APPARATUS AND PROCESS FOR FORMING A MEMENTO FROM CREMATION REMAINS; which claims the benefit to U.S. Provisional Application 63/024,135 filed on May 13, 2020 and entitled APPARATUS AND PROCESS FOR FORMING A MEMENTO FROM CREMATION REMAINS.

### GOVERNMENT LICENSE RIGHTS

None.

### BACKGROUND OF THE INVENTION

### Field of the Invention

The present invention relates generally to a cremation of human or animal remains, and more specifically to an apparatus and a process of forming an object of family value from the cremation remains such as a figurine or a bust or a three-dimensional plaque.

### Description of Related Art Including Information Disclosed Under 37 CFR 1.97 and 1.98

When a family member dies, the remaining family survivors can have the deceased buried in a cemetery or have the body cremated. Having the deceased buried requires purchasing a plot in a cemetery and purchasing a casket used for burial. A much cheaper method is to have the body cremated and take the remains in a vase for storage or to spread in a place that the deceased might have wished for. An average cost of burial with a traditional funeral service is $15,000 while the average cost of cremation with no funeral or burial service is $2,000. Also, an owner of an animal such as a pet cat or dog will have the animal cremated after death and scattering the remains on a special location such as a garden.

There is a need in the art for a system and method that allows for drones to approach homes with exactness and deliver products at a pre-selected designated location around the house to addresses the shortcomings discussed above.

### SUMMARY OF THE INVENTION

An apparatus and a process for forming a 3D object from the remains of a cremation. The cremated remains of a deceased person or animal is mixed with a resin and then poured into a mold to form the desired 3D object which can be a figure or a plaque having a 3D image. In the case of a human, the object can be a 3D bust or the head and neck, or a plaque with a 3D image of the person's face extending out from a flat surface of the plaque, or an object of value to the deceased person or family member such as a bass mounted on a plaque. In the case of an animal such as a cat or a dog, the object could be a 3D image of the cat or dog formed from the cremated remains mix with a resin and formed as the object in a mold or from a 3D printed. In each of the cases of a human or an animal, the solid object can be painted to look like the human face or the animal.

Another method to form the 3D object is to use a 3D printing process using the cremated remains and a bonding agent such as a resin to print the object without the need of a mold.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

### BRIEF DESCRIPTION OF THE SEVERAL VIEWS OF THE DRAWINGS

FIG. 1 shows a process of forming a 3D image from cremated remains according to a first embodiment of the present invention.

FIG. 2 shows a process of forming a 3D image from cremated remains according to a second embodiment of the present invention.

### DETAILED DESCRIPTION OF THE INVENTION

The present invention is an apparatus and a process for forming a 3D structure using the cremated remains from a decreased person that will have a sentimental value for the remaining family member. A decreased person is first cremated, and the cremated remains presented to a family member. The family member will then take the cremated remains to a place that can form a 3D image selected by the decreased before death or by a family member after death. The 3D image can be a small statute or figure that can be placed on a shelf or outdoors, or a 3D plaque that can hang from a wall, or a bust of the person.

The 3D figure can be something that the deceased was interested in and that will bring back memories to remaining family members when they see the 3D figure. The 3D figure can be, for example, a large mouth bass mounted on a plaque if the deceased was fond of bass fishing. The 3D figure can be a 3D picture having a rectangular shape (x,y axis) with topography (z axis) of an image such as a fishing boat in the sea if the deceased was fond of deep-sea fishing, or can be a 3D image of the person's face extending out from the substantially flat plaque instead of a full bust.

In a first embodiment of the present invention, the 3D image is formed using a mold in which the cremated remains are mixed with a resin and the mixture then poured into the mold and solidified. The solid 3D figure is then removed from the mold, painted to look like the person, and then presented to the family member. Molds would have to be formed prior to the casting process to form the desired 3D image or figure. If the cremated remains are not enough material to be mixed with the resin to form the desired 3D figure, a filler material can be added to the cremated remains to have the required ratio of resin and “sand” to form the cast 3D figure.

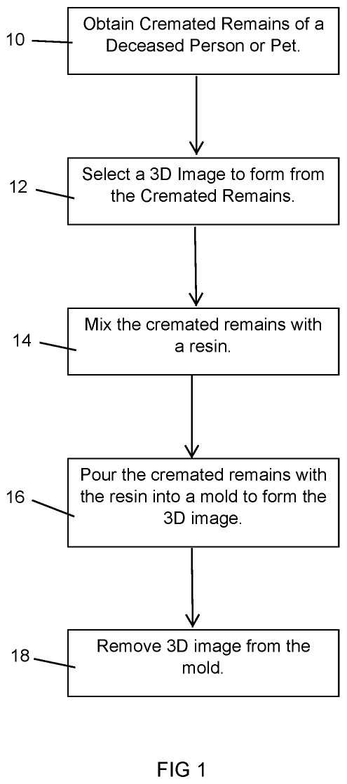

FIG. 1 shows a flow chart of one embodiment of the present invention in which the figure is formed in a mold. Step 10 is to obtain cremated remains of the person or pet (animal) that is to be formed into an object. Step 12 is to select a 3D image to form the figure from the cremated remains such as a bust, a plaque, or a figure of the pet. Step 14 is to mix the cremated remains with a bonding agent such as a resin that will form a solid figure with the cremated remains. Step 16 is to pour the mixture of the cremated remains and the bonding agent into a mold. Step 18 is to remove the 3D image from the mold. Not shown in the FIG. 1 flow chart is the step of painting the 3D image to resemble the human head or face of the pet.

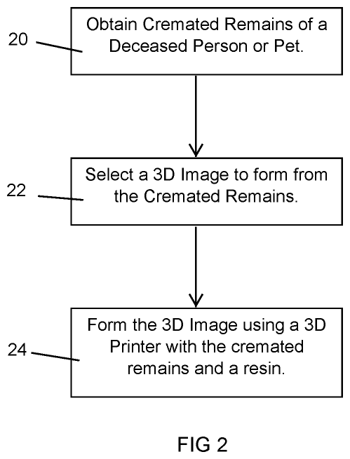

FIG. 2 shows a flow chart of another embodiment of the present invention in which the figure is formed from a 3D printing process. Step 20 is to obtain the cremated remains of the person or the pet. Step 22 is to select a 3D image to form the object of image of the person such as a bust or a face or an animal or a side view of the animal. Step 24 is to form the 3D image of the person or animal image using a 3D printing with the cremated remains as the powder and a resin to solidify the powder to form the 3D image.

In another embodiment of the present invention, the 3D image or figure is formed using a 3D printing process in which the cremated remains (sand-like material) are placed on a printing bed and a resin (such as polyurethane) is deposited on to the sand-like (cremated remains) material to harden the mixture to form the solid 3D image or figure. Using the 3D printing process to form the image or figure does not require a mold and thus any shape can be formed if a computer-generated solid model is first produced. For example, if the cremated remains were to be formed as a large mouth bass, then a computer solid model of a large mouth bass would be used to print the 3D figure using the cremated remains. The 3D printing process can also use colored dyes to produce a colored image on the surface of the 3D printed figure or object.

If the 3D object using the cremated remains is formed using the embodiments of the present invention, the family members can then display the 3D object anywhere they please. In the case of the large mouth bass, the cast or printed figure using the cremated remains can be displayed on a fireplace mantel, or shelf, or placed by a body of water to remind a family member of their deceased relative that liked to fish.

For a family pet such as a cat or a dog, the cremated remains is used to form an object such as a miniature or full-scale model of the pet. For example, if the cremated remains are of a family dog such as a sheltie, the cremated remains can be mixed with a resin and then poured into a mold of a sheltie to harden. Once hardened, the figure of the sheltie is then removed from the mold and the figure of the sheltie is then painted to look like the sheltie that was cremated. The mold can be for a scaled down version of the animal since not enough cremated remains might be available to form a full-sized figure of the animal. Also, an animal such as a sheltie dog come in various sizes, and thus several molds would be needed to form different sizes of these dogs. One or two molds can be used to form a figure of a sheltie dog. If the owner desires to have a certain shape not available in the molds in stock, then the figure of the animal can be formed using the 3D printing process.

For the cremated remains of a human, a 3D bust of the person's head and neck might not be desired. In this case, a plaque can be formed in which a 3D image of the person's face can be created that extends outward from the substantially flat surface of a plaque. For use in the description of the present invention, a plaque is a rectangular shaped piece in which a 3D object extends outward from in which the plaque is thin but thick enough to support the 3d image that extends outward therefrom. In this embodiment, a 3D printer can be used to print the 3D image of the person's face that can then be placed on the substantially flat surface of a rectangular shaped plaque. The flat plaque can be formed from a material other than using the cremated remains of the person or animal. The 3D image of the person's face can be placed over the recently poured material that forms the flat [plaque surface before the flat plaque surface dries and hardens to secure the 3D image to the plaque. Or the 3D image can be glued to the flat plaque surface after the flat plaque surface has hardened. The flat plaque surface with the 3D image extending outward can also be used for the animal remains.

In another embodiment of the present invention, a deceased person might have indicated while still alive or as described in a will that the deceased person desired to be cremated and the remains used to form a figure that has sentimental value to that person. For example, the deceased person might have been fond of ballet and thus wishes to have her cremated remains used to form a figurine of a ballet dancer. In another version, the deceased person might have had an interest in mermaids and thus wishes to have her cremated remains used to form a mermaid figure that can then be dropped into a body of water. In each of these cases, the figure can be painted to resemble the person or the object such as the mermaid.

In summary, the present invention is an apparatus and a process of forming a figure of a deceased human or pet using the cremated remains of the human or pet in which the figure has a resemblance of the person or pet. The figure can be a full size or scaled down bust of a person's head, or a flat plaque with a 3D image of the person's face or a side view of a pet extending outward from the flat surface of the plaque, or a full sized or scaled down image of the pet such as a dog or a cat or even a horse. In the case of an animal, the figure can be formed from a mold in which the cremated remains are mixed with a resin and then poured into the mold. When the image or figure is removed from the mold, the image or figure can be painted to resemble the human face or pet.

The main feature of the present invention is to keep the cremated remains from a deceased family member or pet but in a 3D image that will produce fond memories unlike those from a generic vase filled with a powdery substance that is unrecognizable to that family member.

We claim the following:

1. A process of forming a 3D object from cremated remains of a deceased person or pet comprising the steps of:
cremating a deceased person or pet;
obtaining the cremated remains of the deceased person or pet;
created a 3D object using the cremated remains and a bonding agent; and,
painting the 3D object with the cremated remains to resemble the deceased person or pet.

2. The process of forming a 3D object from cremated remains of claim 1, and further comprising the steps of:
mixing the cremated remains with a resin; and,
pouring the mixture of the cremated remains and the resin into a mold.

3. The process of forming a 3D object from cremated remains of claim 1, and further comprising the steps of:
forming the 3D object using a 3D printing process.

4. The process of forming a 3D object from cremated remains of claim 1, and further comprising the steps of:
the 3D object is a figure of a pet.

5. The process of forming a 3D object from cremated remains of claim 1, and further comprising the steps of:
the 3D object is a bust of a person.

6. The process of forming a 3D object from cremated remains of claim 1, and further comprising the steps of:
the 3D object is a 3D image of a person's face or a side view of a pet extending outward from a substantially flat surface of a rectangular plaque.

7. A 3D shaped image of a person or a pet comprising:
cremated remains of a person or a pet;
a bonding agent to form a solid object of the 3D shaped image; and,
a surface of the 3D shaped image painted to resemble the person or the pet.

8. The 3D shaped image of a person or a pet of claim 7, and further comprising:
the 3D shaped image is a bust of a person.

9. The 3D shaped image of a person or a pet of claim 7, and further comprising:
the 3D shaped image is a figure of the pet.

10. The 3D shaped image of a person or a pet of claim 7, and further comprising:
the 3D shaped image is a face of the person.

11. The 3D shaped image of a person or a pet of claim 7, and further comprising:
the 3D shaped image is a side view of the pet.

12. A 3D shaped object comprising:
cremated remains of a person;
a bonding agent mixed with the cremated remains to form a solid figure; and,
the surface of the 3D shaped image is painted to resemble an image sentimental to a person whose cremated remains was used to form the object.

13. The 3D shaped image of claim 12, and further comprising:
the 3D shaped object is a fish or an animal or a bird or a cartoon character.
